(19) United States
(12) Patent Application Publication
(10) Pub. No.: US 2014/0217645 A1
(43) Pub. Date: Aug. 7, 2014

(54) MOULDING METHODS AND APPARATUS

(71) Applicant: Karl-Heinz Schmitt, Rynfield (ZA)

(72) Inventor: Karl-Heinz Schmitt, Rynfield (ZA)

(21) Appl. No.: 14/232,113

(22) PCT Filed: Jul. 11, 2012
(86) PCT No.: PCT/IB2012/053539

§ 371 Date: Mar. 26, 2014

Related U.S. Application Data
(60) Provisional application No. 61/599,193, filed on Feb. 15, 2012.

(30) Foreign Application Priority Data
Jul. 11, 2011 (GB) 1111872.6

(51) Int. Cl. B29C 45/28; B29C 45/23

(52) U.S. Cl. CPC B29C 45/281; B29C 45/23; B29C 2045/2855
USPC 264/328.1; 251/324

(57) ABSTRACT

Valves (110) and other apparatus, methods of moulding and moulds (112) are provided for the moulding of materials such as injection or injection-compression moulding of molten thermoplastic materials. The valve includes a valve element/piston (126) that is orientated at 60 degrees relative to the mould's bounding wall (116) and that can reciprocate in a barrel (122) and that can rotate. The piston (126) h a leading face (128) that is also orientated at 60 degrees, so that the flow passage/melt channel (118) extends past the leading face (128) when the valve (110) is open and the leading face (128) forms part of the bounding wall of the mould cavity (114) when the valve is closed. The piston (126) is advanced or retracted a very short distance and is rotated through 180 degrees, to open and close the valve (110). The other apparatus include multiple flow passage and valve elements that feed single or multiple mould cavities to allow improved moulding of articles in conventional injection moulding machines through multiple flow passages.

### FIELD OF THE INVENTION

This invention relates to the moulding of materials such as injection or injection-compression moulding of molten thermoplastic materials. In particular, the invention relates to valves to close mould cavities, methods of moulding and moulds.

### BACKGROUND TO THE INVENTION

Conventional injection moulding includes supplying mouldable material to a mould cavity along runners and gates, but design constraints of the gates limited the sizes of the flow passages leading to the mould cavities. Recent developments include the use of larger diameter flow passages and pistons that close the flow passages so that the leading faces of pistons form part of the mould cavities' bounding walls at the forward ends of their forward (working) strokes. These pistons can also be cooled internally and hold a number of advantages, particularly in that the increased diameters of the flow passages prevent excessive shear and fibre breakage in the flowing mouldable materials, and the internal cooling of the pistons allow short cooling times and prevent unsightly markings on the moulded parts.

WO 2007/049146 provides examples of the moulding techniques described above. A process is described in WO 2007/049146 in which molten plastic material is fed to a mould cavity and in the final part of this process, a packing piston urges the last molten material into the mould and at the end of its forward stroke, the face of the packing piston becomes part of the bounding wall of the mould. In order to ensure that moulded material in contact with the piston face inside the mould cavity is frozen with the rest of material inside the mould, the piston face is cooled internally. Further, in order to ensure that molten material fed to the mould does not freeze until it reaches the mould cavity, the entire flow path externally of the mould, is heated. WO 2007/049146 also discloses the use of multiple packing pistons, each feeding molten material to the mould cavity.

Pistons of the type described above, that travel purely linearly and that are cooled internally, hold a number of disadvantages and challenges. During the last part of the forward stroke of the piston, it closes off the passages that supply material to the cylinder in which the piston operates and the material in the cylinder in front of the piston, is forced into the mould cavity. This step in is referred to as “packing” on WO 2007/049146. It is possible to ensure that the volume of material that enters the mould cavity before packing and the volume of material that enters the mould cavity during packing are adequate to maintain the desired volumetric mould filling, pressure and flow rates. However, there are risks of over/under filling of moulds, undesirable increases or decreases in pressure or flow rate, etc. during the packing stroke of the piston.

In some arrangements, the piston should preferably be operated by mechanisms housed within the mould (i.e. between the platens of the moulding machine's press), e.g. if multiple pistons are used and/or if the pistons do not line up with apertures in the platens of the moulding machine. In order to provide the forces needed to force the last mouldable material into the mould cavity, the pistons need to be driven hydraulically, but the hydraulic mechanisms are cumbersome and are prone to leakage.

Present practice in injection moulding is to fit a mould comprising two (or sometimes more) parts between two platens of a press, which hold the mould parts together in a closed condition during the moulding and cooling phases and which opens the mould at the end of the mould cycle. The platens typically include a static platen and a moving platen that is connected to hydraulic pistons, or the like, to open and close the mould. When the mould is closed, the molten material is fed through a nozzle into the mould cavity inside the mould and to reach the mould cavity from outside the mould, the nozzle extends through an aperture in the static platen of the press.

When implementing the developments of WO 2007/049146, molten material needs to be fed through the aperture in the static mould platen into the mould cavity and the packing piston needs to urge the last of the molten material along this path.

Accordingly, the stoke of the packing piston needs to be long enough so that at the end of its return stroke, its face is outside the aperture in the static platen to leave space for the flow of molten material through the aperture—which is quite far from its position at the bounding wall of the mould cavity, at the end of its forward stroke.

The long stroke of the packing piston means that it, and the equipment which drives it, extend far outside the static platen, with the result that the moulding machine is very large.

Further, the embodiments described in WO 2007/049146 in which multiple packing pistons are used, cannot be implemented in a conventional press, because the pistons need to pass through the static platen and there is only sufficient space for a single piston.

A single mould often includes multiple mould cavities, in which multiple products can be moulded simultaneously. However, in conventional injection moulding, the mouldable material is supplied at a single pressure and it is extremely difficult to manufacture in a single conventional injection mould, different products that require a large difference in the volume of mouldable material supplied to the mould cavity (i.e. its “shot size”). The process is optimised through physically changing the size of the runners and gates.

Typically, the manufacture of moulded products in conventional injection moulding is limited to the production of a single product if a mould has a single cavity or multiples of the same product if the mould has more than one cavity. If a product requires the manufacture and assembly of a number of differently-shaped and sized injection-moulded components, these components have to be moulded in more than one injection mould where the conditions of pressure and gate size match the manufacturing and control needs of the specific component produced by that mould. The components then have to be sorted, grouped and groups shipped separately, to be assembled before use. This results in extra costs and complexity in the manufacturing of to-be-assembled products.

There is often a need to manufacture products with part of its structure made from one material and with a different material covering it on the outside. Typically, the first material would be selected for its mechanical properties and/or cost, e.g. it could be a strong composite with fibres embedded in a polymer, or it could include cost-effective cellulosic waste materials as fillers. The outside materials would be selected for aesthetic appeal, e.g. to give a so called “A-class” finish or to provide a soft touch. When these products are manufactured using conventional injection moulding techniques, the first (internal) part is moulded and then placed in a second mould, which defines the cavity to be filled by the second material, or the second material is applied using a different technique, e.g. autoclave or the like. It would have very significant cost advantages if such a two-part product could be injection moulded in a single mould.

Other difficulties that are inherent to injection moulding equipment, include: the fact that conventional moulding often requires runners or other formations external to the moulded part, to be removed and its material wasted or recycled; the gate size needs to be increased to reduce shear (which causes attrition of reinforcing fibre length) and the larger gate size limits its positioning in the mould, often increases cycle times because the gate is larger than product thickness and creates sprues that require a secondary removal step after de-moulding the product; the configurations of flow passages and moulding cycles that cause excessive shear within the flowing material being moulded, which damages fibres embedded in the material; the need to compensate for thermal expansion and contraction of parts during the moulding cycle; formation of weak spots and/or weld-lines in the moulded parts; and formation of piston marks on moulded parts.

The present invention seeks to address the difficulties described above, relating to the feeding of material into a mould with one or more packing pistons and it is not limited to addressing difficulties arising from WO 2007/049146, but also seeks to address other difficulties inherent to injection moulding, including those difficulties mentioned above.

The present invention seeks to provide for closure of a mould cavity which has the same advantages of the packing pistons described above, but without the disadvantages described above.

### SUMMARY OF THE INVENTION

According to one aspect of the present invention there is provided a method of closing a flow passage leading to a cavity, said method comprising:
providing a piston that is reciprocally displaceable in a barrel and that is rotatable about a longitudinal axis of the barrel, part of said barrel forming part of said flow passage adjacent the cavity, said barrel being orientated at an angle of about 60 degrees relative to a bounding wall of the cavity, and said piston having a leading face oriented at about 60 degrees from the longitudinal axis of the barrel;
displacing the piston longitudinally in the barrel in a forward stroke until the centre of its leading face is generally aligned with the bounding wall of the cavity; and
rotating the piston about the barrel's longitudinal axis until its leading face is generally aligned with the bounding wall of the cavity, in a forward position of the piston.

The phrase “about 60 degrees” refers in this specification to an acute angle that is preferably 60 degrees, but that could deviate from 60 degrees. The angle could be between 40 and 80 degrees, but preferably between 50 and 70 degrees and more preferably as close as possible to 60 degrees. A reference to “60 degrees” (without the prefix “about” is not limited to exactly 60 degrees, but to an angle that does not deviate appreciably from 60 degrees.

The cavity may be a mould cavity, i.e. the method may relate to closing of a passage though which material is fed to a mould and the examples of this aspect of the invention described below, also relate to mould cavities. However, this aspect of the invention can be used in many applications other than moulding.

The method may be preceded and/or followed by opening the flow passage by: displacing the piston longitudinally in the barrel in a return stroke until the centre of its leading face is retracted from the bounding wall of the cavity, preferably by a distance at least about half the diameter of the barrel; and rotating the piston about the barrel's longitudinal axis, preferably through about 180 degrees until the piston is in a retracted position.

The steps of longitudinal displacement of the piston and rotating the piston about the barrel's longitudinal axis, during opening and/or closing of the valve, may take place in any order and/or simultaneously.

According to another aspect of the present invention there is provided a method of moulding an article, said method comprising:
opening a valve as described herein above;
passing mouldable material along said flow passage into the cavity, said flow passage including a supply passage and the part of the barrel that is between the cavity and the leading face of the piston;
closing the valve as described herein above; and
allowing the mouldable material to solidify.

The method may include a subsequent step of cooling the leading face of the piston.

According to a further aspect of the present invention there is provided a valve for closing a flow passage leading to a cavity, said valve comprising:
a piston that is reciprocally displaceable in a barrel and that is rotatable about a longitudinal axis of the barrel, part of said barrel forming part of said flow passage adjacent the cavity, said barrel being orientated at an angle of about 60 degrees relative to a bounding wall of the cavity, and said piston having a leading face oriented at about 60 degrees from the longitudinal axis of the barrel; and
a supply passage in flow communication with the barrel in close proximity to the bounding wall of the cavity, said supply passage and barrel forming part of the flow passage.

The cavity may be a mould cavity.

The supply passage preferably joins the barrel with an orientation at an angle of about 60 degrees relative to the bounding wall of the cavity, in an orientation that generally mirrors the orientation of the barrel, relative to a mirror axis that extends generally perpendicular to the bounding wall of the cavity.

The piston may define an internal flow passage that is connectable to a source of coolant and that is in thermal contact with the leading face of the piston.

The flow passage may be in communication with the cavity via an opening defined in the bounding wall and the opening may have an oval shape and has a cross-sectional area that is about 8% larger than the cross-sectional area of the flow passage.

According to another aspect of the present invention there is provided a method of moulding and article, said method including:
opening at least one first flow passage leading to a main mould cavity by withdrawing at least one first valve element;
advancing at least one second valve element to close a second flow passage leading to said main mould cavity, said first and second flow passages being defined in a stationary part of a mould that defines said main mould cavity;
feeding flowable material under pressure to the main mould cavity along said first flow passage;
closing said first flow passage by advancing said first valve element; and
allowing the material in the main mould cavity to solidify and form a first part of the article;
wherein, when the second valve element is advanced to close the second flow passage, it is advanced to extend across the mould cavity; and said method further including:
withdrawing the second valve element to form an aperture in the first part of the article and to open the second flow passage;
forming an ancillary mould cavity adjacent the first part of the article, at least part of said ancillary mould cavity being on a side of said first part of the article that is opposite from the stationary part of the mould, said ancillary mould cavity being in communication with the second flow passage via the aperture in the first part of the article;
feeding flowable material under pressure to the ancillary mould cavity along said second flow passage;
closing said second flow passage; and
allowing the material in the ancillary mould cavity to solidify.

The method may include advancing the second valve element to butt against a bounding wall of the main mould cavity on a side of the main mould cavity that is opposite from the stationary part of the mould, when advancing said second valve element to extend across the mould cavity.

According to another aspect of the present invention there is provided a mould comprising multiple parts, said mould comprising:
a first mould part that is configured to be displaceable, in use, said first mould part defining a first part of a bounding wall extending around a mould cavity;
a second mould part that is configured to remain stationary, in use, said second mould part defining a second part of a the bounding wall, said second mould part further defining at least one first flow passage leading to the mould cavity and at least one second flow passage leading to the mould cavity;
at least one first valve element disposed to close each first flow passage selectively; and
at least one second valve element disposed to close each second flow passage selectively;
wherein said second valve element is configured to advance across the mould cavity, when closing the second flow passage.

The second valve element may be configured to butt against the second bounding wall, when closing the second flow passage.

Each of the first and second valve elements may be disposed wholly inside the stationary part of the mould.

Each of the flow passages has a diameter of at least 10 mm and includes smooth, rounded bends. Preferably, the flow rate of the flowable material inside the flow passages is less than 1 m/s.

According to another aspect of the present invention there is provided a method of moulding a plurality of parts for assembly to form a product, said method comprising:
providing a supply of mouldable material;
feeding the mouldable material via a plurality of flow passages to a plurality of mould cavities, said flow passages and mould cavities being defined in a single mould and at least some of said mould cavities having different shapes and substantially different volumes;
urging the mouldable material from the flow passages into the mould cavities and closing each flow passage with a valve element, a face of each of said valve elements becoming part of the bounding wall of one of the mould cavities, upon closing the flow passage;
wherein the flow passages and the valve elements closing the flow passages are of different sizes and cause the flow rate of the mouldable material in the flow passages and mould cavities to be less than 1 m/s.

The method may include opening and closing the flow passage with the valve elements in a predetermined sequence, to affect urging of the mouldable material into the mould cavities in a predetermined sequence.

Each valve element may be a piston and the step of urging the mouldable material from the flow passages into the mould cavities may comprise advancing the pistons, each piston being disposed in one of said flow passages and the leading face of each of said pistons becoming part of the bounding wall of one of the mould cavities, upon reaching the limit of a forward stroke of the piston.

The valve elements may be driven and controlled electrically.

The method may include closing the mould before urging the mouldable material into said moulding cavities, or closing the mould after urging the mouldable material into said moulding cavities has commenced.

According to another aspect of the present invention there is provided a mould comprising multiple parts which, when placed together in a closed condition, define an internal mould cavity, at least one of said parts of the mould defining a flow passage that is in communication with the outside of the mould and with a transition passage, said transition passage opening into the mould cavity at a discharge port; wherein a valve element is disposed inside said mould part and is reciprocally displaceable along the transition passage between a retracted position in which the flow passage is in communication with the transition passage and the discharge port is open; and a forward position in which the valve element obstructs communication between the flow passage and the transition passage and closes the discharge port, so that a leading face of said valve element forms part of the bounding wall of the mould cavity in the discharge port, when it is in said forward position.

By “inside” the mould part is meant that the valve element is fits physically inside a part of the mould, but also includes a configuration where a part of the valve element may protrude outside the mould part, as long as it still fits on the same side of a platen of an injection moulding press, as the mould cavity.

The same mould part may define a back surface at the outside of the mould, where it would typically press against the static platen, and an inlet port in the back surface, said inlet port being in communication with the flow passage and said discharge port being disposed on a side of said mould part that is opposite from said inlet port.

The mould part may include a driving mechanism for actuating the valve element to reciprocate between its retracted and forward positions and the driving mechanism may include at least one hydraulic cylinder—preferably multiple double acting cylinders, and may be disposed internally, inside said mould part.

The valve element may be internally cooled, e.g. with an internal water jacket extending, in particular, behind its leading face. Further, the walls of the transition passage may be heated.

The end of the flow passage that is in communication with the transition passage, may extend generally parallel to the transition passage and may be eccentrically disposed on one side of the transition passage, to prevent division of the flow of material through these passages and thus to prevent weld-lines

The mould may include a plurality of said valve elements, each associated with a flow passage and a transition passage as described herein above and each of the valve elements may be configured to reciprocate between its retracted position and its forward position along its associated transition passage, as described herein above.

The plurality of flow passages may be in communication, i.e. connected to one another, and may be in communication with a single inlet port of the mould part.

The invention extends to a moulding machine which includes a mould as described herein above.

According to a further aspect of the present invention there is provided a method of moulding and article, said method including:
feeding flowable material under pressure to an inlet port of a mould;
feeding said flowable material from said inlet port into a mould cavity, via a flow passage, a transition passage and a discharge port, all defined in the mould;
closing communication between the flow passage and the transition passage and feeding said flowable material from the transition passage into the mould cavity with a forward stroke of a valve element along the transition passage; and
closing the discharge port with the leading face of the valve element at the end of its forward stroke, such that the leading face of the valve element becomes part of the bounding wall of the mould cavity;
wherein the valve element is disposed inside the mould.

The valve element may start its forward stroke while flowable material is still flowing from the flow passage into the transition passage, so that the flow of flowable material is uninterrupted during the process.

Instead, the mould cavity may be filled with said feed of flowable material before the valve body starts its forward stroke. Preferably, the flowable material in the flow passage and transition passage is kept under pressure to compensate for shrinkage of material in the mould until the valve body ends its forward stroke.

The method may include feeding the flowable material to the mould cavity via multiples of the flow passages, transition passages and discharge ports, and urging flowable material from each transition passage into the mould cavity with a valve element, as described herein above.

The method may include feeding the flowable material to the flow passages from a common inlet port on the mould and the forward strokes of the valve elements may take place sequentially.

The valve element may be cooled, at least in part, and at least when the rest of the bounding wall of the mould is cooled and the cooling of the valve element may be controlled.

According to a further aspect of the present invention there is provided a method of injection moulding an article with a flowable material including long glass fibres, wherein fibre breakage is inhibited, said method including:
feeding the flowable material under pressure to an inlet port of a mould;
feeding said flowable material from said inlet port into a mould cavity, via a flow passage, a transition passage and a discharge port, all defined in the mould;
closing communication between the flow passage and the transition passage and feeding said flowable material from the transition passage into the mould cavity with a forward stroke of a valve element along the transition passage; and
closing the discharge port with the leading face of the valve element at the end of its forward stroke, such that the leading face of the valve element becomes part of the bounding wall of the mould cavity;
wherein the valve element is disposed inside the mould; each of said flow passage, transition passage and discharge port has a diameter of more than 10 mm; and all bends in the flow passage and transition passage are smooth and rounded.

The flow rate of the flowable material in the flow passage and transition passage may be less than 1 m/s.

The valve element may start its forward stroke while flowable material is still flowing from the flow passage into the transition passage, so that the flow of flowable material is uninterrupted during the process.

Instead, the mould cavity may be filled with said feed of flowable material before the valve body starts its forward stroke. Preferably, the flowable material in the flow passage and transition passage is kept under pressure to compensate for shrinkage of material in the mould until the valve body ends its forward stroke.

The method may include feeding the flowable material to the mould cavity via multiples of the flow passages, transition passages and discharge ports, and urging flowable material from each transition passage into the mould cavity with a valve element, as described herein above.

The method may include feeding the flowable material to the flow passages from a common inlet port on the mould and the forward strokes of the valve elements may take place sequentially.

The valve element may be cooled, at least in part, and at least when the rest of the bounding wall of the mould is cooled and the cooling of the valve element may be controlled.

### BRIEF DESCRIPTION OF THE DRAWINGS

For a better understanding of the present invention, and to show how the same may be carried into effect, the invention will now be described by way of non-limiting example, with reference to the accompanying drawings in which:

FIG. 1 shows a sectional side view of part of a mould in a first embodiment according to the present invention, with a valve element of said mould in its retracted position;

FIG. 2 shows a detail sectional view of a part of a mould of FIG. 1, with its valve element in its forward position;

FIG. 3 shows a sectional side view of part of a mould in a second embodiment of the present invention;

FIG. 4 shows a sectional side view of part of a mould in a third embodiment of the present invention.

FIG. 5 is a sectional view of an alternative embodiment of a valve in accordance with the present invention, in an open condition, in position in a mould;

FIG. 6 is a sectional view of the valve of FIG. 5, in a closed position;

FIG. 7 is a three dimensional view of the valve of FIG. 5, with components of its actuating mechanism;

FIG. 8 is a sectional view through part of the actuating mechanism of the valve of FIG. 5;

FIG. 9 is a diagrammatic representation of a first stage in an injection moulding method in accordance with the present invention and

FIG. 10 is a diagrammatic representation of a subsequent step of the method shown in FIG. 9.

### DETAILED DESCRIPTION OF THE DRAWINGS

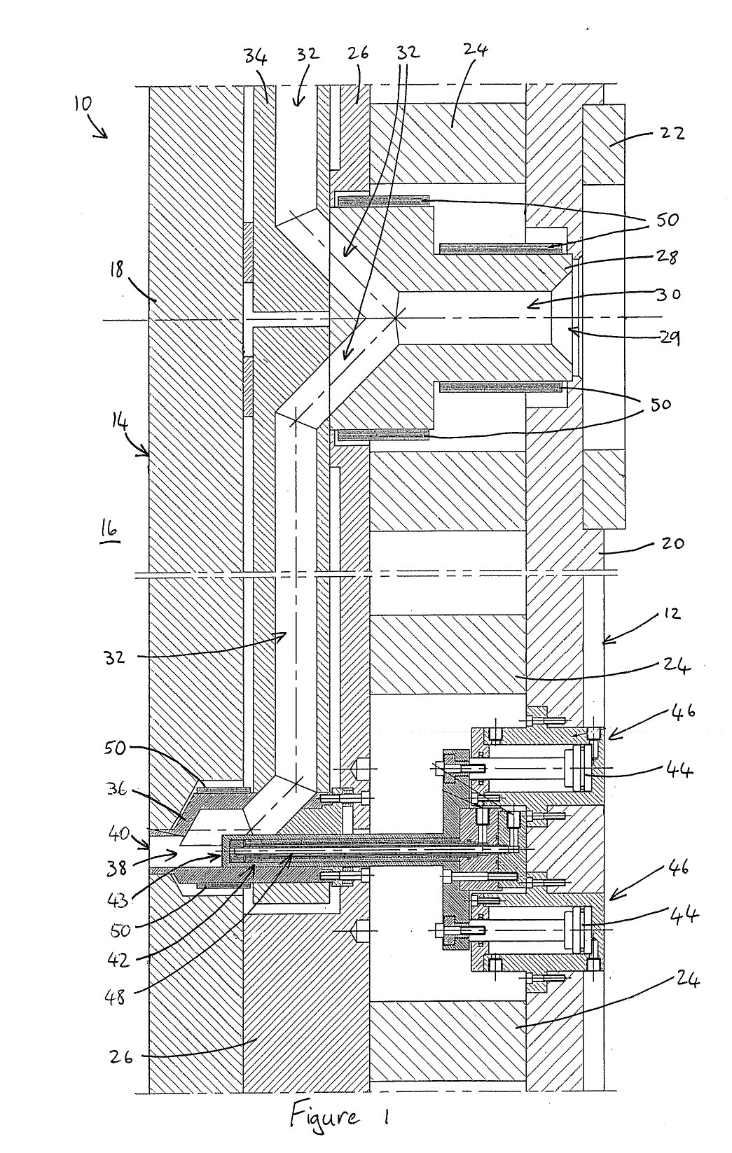

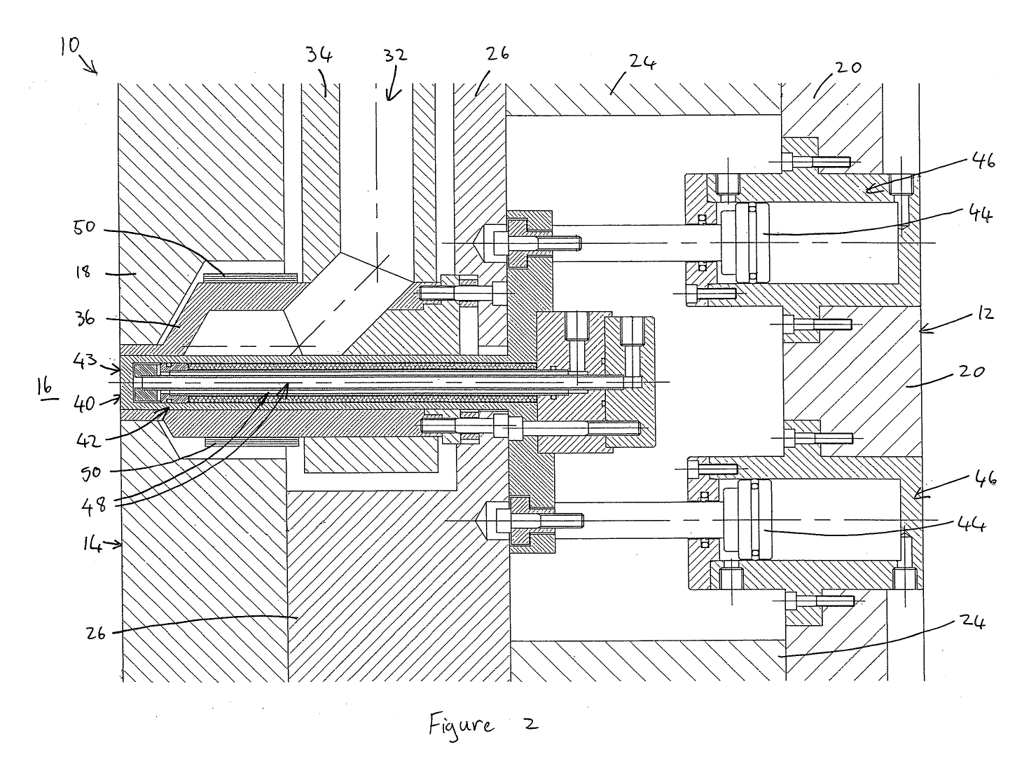

Referring to FIGS. 1 and 2, a mould according to a first embodiment of the present invention is generally identified by reference numeral 10. Only a part of the mould 10 is shown, said part having a back wall 12 on one side and a surface on the opposing side which forms a bounding wall 14 of a mould cavity 16, when the mould is closed. Those skilled in the art would understand that the mould 10 would typically include at least one more part that can be pressed together so that the mould cavity 16 is formed between them. In a conventional injection moulding press, a static platen (not shown) would be attached against the back wall 12 (from the right as shown in FIG. 1) and the part of the mould that is not shown, would be attached to a moving platen of the press.

For the sake of simplicity, reference numeral 10 and the word “mould” are used herein to refer to the part of the mould that is shown.

The bounding wall 14 of the mould cavity 16 is formed by a mould plate 18, which is in the form of a thick metal plate and on the opposite side of the mould 10; the back wall 12 is also formed by a thick metal plate in the form of a back plate 20. The mould plate 18 and back plate 20 are exceptionally sturdy; to ensure dimensional stability of the mould 10, especially under the extremely high pressures which the mould may need to endure. The mould plate 18 and back plate 20 are spaced apart by a similarly sturdy internal structure which includes a number of raisers 24 and a support plate 26, with cavities defined by the support plate and between the raisers.

At the centre of the back wall 12, a centring ring 22 is set in the back plate 20 and protrudes from the back wall. The centring ring 22 is intended to be received in a complemental recess in a static platen of an injection moulding press and assists in ensuring correct positioning of the mould 10.

A central injection bush 28 is provided between the raisers 24 and is aligned with the centring ring 22. The injection bush 28 defines an inlet port 29 that is generally central on the back wall 12, and an internal central flow passage 30 that leads from the inlet port and that is in communication with (i.e. continuous with) a number of branch flow passages 32. In FIG. 1 only two branch flow passages 32 are shown, but the mould 10 could include one or any other number of branch flow passages. Each branch flow passage 32 continues from the injection bush 28, internally along a distribution arm 34 that fits inside a recess in the support plate 26.

A valve body 36 is provided at the end of each distribution arm 34 and the branch flow passage 32 continues (i.e. is in communication) from the distribution arm, internally inside the valve body, up to a point where it joins a transition passage 38, which extends to a discharge port 40 at the end of the transition passage, flush with the bounding wall 14 of the mould cavity 16.

An elongate valve piston or element 42 is provided in each transition passage 38 and is reciprocally displaceable along the transition passage between a retracted position shown in FIG. 1, in which the branch flow passage 32 is in communication with the transition passage and the discharge port 40 is open, and a forward position shown in FIG. 2, in which the valve element fills the transition passage so that it is no longer in communication with the branch flow passage and so that the port 40 is closed by a leading face 43 of the valve element—the leading face being flush with, and forming part of the bounding wall 14.

At the end of the branch flow passage 32 where it joins the transition passage 38, it extends generally parallel to the transition passage, but is offset or eccentrically disposed on one side of the transition passage. The branch flow passage 32 also extends to a point quite close to the discharge port 40.

At the base of the valve element 42, it is connected to a driving mechanism comprising two (although it could be one or any other number) double acting hydraulic pistons 44, each housed in a hydraulic cylinder 46, for actuating the valve element to reciprocate between its retracted and forward positions. The base of each valve element 42 also has provision for receiving and discharging a coolant such as water, which flows along internal cooling passages 48 inside the valve element. The cooling passages 48 are configured for coolant to flow centrally along the valve element 42 towards its face, radially near the face and to return along an annular flow path. Accordingly, the cooling passages 48 are configured to cool the tip of the valve element and in particular, the leading face 43 of the valve element, when coolant flows in the passages.

The mould plate 18 defines internal cooling passages (not shown) through which a coolant such as water can flow to cool the mould plate—particularly the bounding wall 14.

The injection bush 28 and valve body 36 are each provided with external heating bands 50 and these parts are in close mechanical contact with the distribution arms 34 and heat is transferred between these parts as material flows along the branch flow passages 32. Mechanical contact between the injection bush 28 and the support plate 26 and back plate 20 is minimal, to reduce heat transfer from the injection bush to the rest of the mould 10 and similarly, mechanical contact between the distribution arms 34 and the support plate 26 and mould plate 28 are minimal to reduce heat transfer from the distribution arms to the rest of the mould.

From the description above, it is clear that the mould 10 includes multiple branch flow passages 32, each with its own associated valve body 36 and valve element 42, even though only one valve body and valve element is shown in each of the drawings. Further, only a single mould cavity 16 is shown, but in other embodiments of the invention, the mould could define multiple mould cavities, each supplied via at least one of the discharge ports 40.

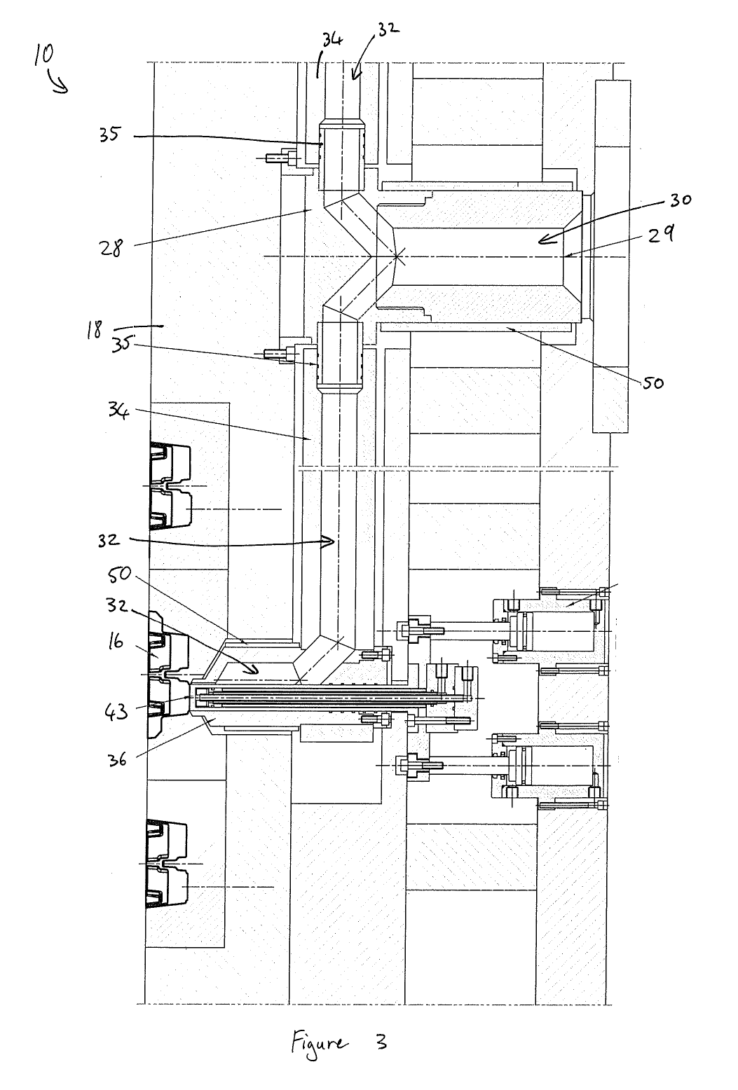

Referring to FIG. 3, the mould 10 according to the second embodiment of the present invention is substantially similar to that shown in FIGS. 1 and 2, although the mould plate 18 as shown in FIG. 3 includes a number of profiled inserts that assist in defining the mould cavity 16. Further, each distribution arm 34 as shown in FIG. 3, is fixedly attached to its associated valve body 36 and is attached to the injection bush 28 via an expansion bush 35 that fits tightly within recesses defined in the distribution arm and the injection bush, respectively. As the distribution arm 34 is exposed to varying temperatures, it expands and contracts longitudinally, but the expansion bush 35 slides relative to the distribution arm in a sealing manner, thus allowing the thermal expansion/contraction to take place without transferring significant forces from the distribution arm to the injection bush 28. This arrangement compensates for sealing along the length of the branch flow passages 32, despite a relatively large diameter of the branch flow passages.

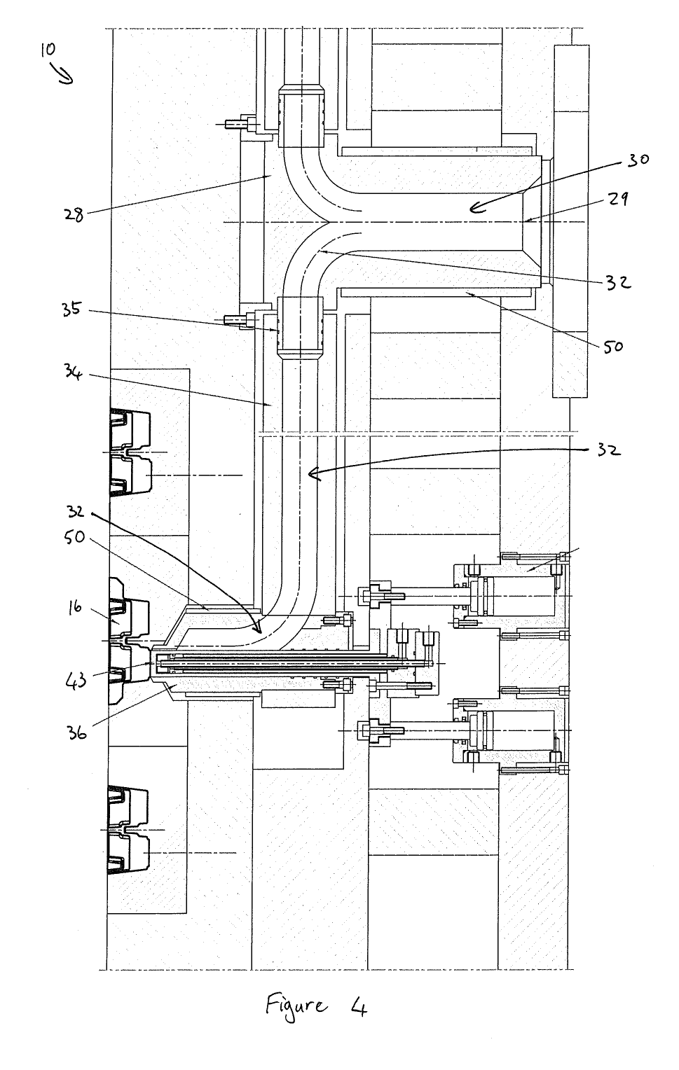

In order to minimise internal shear in the flow of material inside the central flow passage 30, branch flow passages 32 and transition passages 38, these passages all have relatively large diameters and they do not include any right angled or other sharp turns. In the embodiments shown in FIGS. 1 to 3, the passages 30, 32 and 38 change direction by 45 degrees at a time, but in the embodiment shown in FIG. 4, the passages are curved/rounded and change direction smoothly. The reduction in internal shear forces reduce the likelihood that fibres embedded in flowable material flowing in these passages 30, 32, and 38, will break.

In use, a flowable material such as a molten thermoplastic material with embedded fibres, is supplied to the mould 10 under pressure from a conventional extruder, from a dosing piston, or the like and is supplied in the conventional manner to a supply port at the centre of the static platen of an injection moulding press on which the mould has been fitted. The inlet port 29 is generally in register with the supply port and the molten material flows into the mould 10 through the port 29 and along the central flow passage 30 and is divided to flow along each of the branch flow passages 32 to the respective valve bodies 36. As described above, the injection bush 28, distribution arms 43 and valve bodies 36 are directly or indirectly heated, so that the molten material is kept at a sufficiently elevated temperature (typically in the region of 250 degrees Celsius) along the entire flow passage, to prevent freezing.

At the start of an injection cycle, the valve elements 42 are retracted (as shown in FIG. 1) and the mould 10 is closed. The molten material thus flows along the flow passages 30,32 as described above and flows through the transition passages 38 and discharge ports 40 into the mould cavity 16. During this time, the supply of coolant to the valve elements 42 is closed, so that the leading faces 43 and adjacent parts of the valve elements are rapidly heated by the adjacent valve body 36 and hot flowing material and the elevated temperature of these parts of the valve elements prevent unwanted freezing of material at the leading faces 43.

When a sufficient quantity of molten material has been fed into the mould cavity 16, the valve elements 42 can start their forward strokes and close of the flow of material from the flow passages 32 and urge the remaining material from the transition passages 38 into the mould cavity until the valve elements reach their forward positions (as shown in FIG. 2) and their leading faces 43 become part of the bounding wall 14. The valve elements 42 can start their forward strokes while the molten material is still flowing from the flow passages 32 into the transition passages 38, so that the flow of the molten material is uninterrupted during the process.

In some embodiments, the valve elements 42 are configured to feed the molten material in a sequence, e.g. they can be cascaded to fill the mould cavity 16 from one side to another while maintaining a continuously flowing melt face, or to fill the mould cavity in any other desired manner, minimising or managing weld lines, visual imperfections and the like. Basically, the multiple valve elements 42 allow flexibility and control of the filling of the mould cavity 14, with a myriad of advantages.

Once the valve elements 42 reach their forward positions, the mould plate 18 and valve elements are cooled internally to freeze the material inside the mould cavity 16 and produce a moulded article. Once the molten material has frozen, cooling of the mould plate 18 and valve elements 42 ceases, the mould 10 is opened and the moulded article is ejected. The mould 10 is closed again and the valve elements 42 retracted, so that the mould 10 is ready for its next injection cycle.

However, in a preferred embodiment of the present invention, the flow of material into the mould cavity 16 continues under pressure applied externally from the mould 10 (i.e. from the dosing piston) until the mould cavity has been filled completely and the pressure on the supply of flowable material is maintained for a “dwell” period of a few seconds (depending on the width of the mould cavity—which equates to the wall thickness of the moulded article). During the dwell period, the bounding walls of the mould 14 are cooled and material in the mould cavity 16 starts to freeze and shrinks a small amount, but flowable material from the transition passage 38 can still flow into the mould cavity 16 under pressure and compensates for the shrinkage. At the end of the dwell period, the valve element 42 starts its forward stroke and most of the material in the transition passage 38 is urged back into the branch passage 32, until the leading face 43 of the valve element reaches the end of the branch flow passage. Only once the valve element 42 reaches the end of its forward stroke, does internal cooling of its leading face 43 commence, but this cooling takes place quite rapidly, so that material in the mould cavity 16 adjacent the leading face 43 freezes in the same time as material in the rest of the mould cavity. With this configuration, only a very small volume of flowable material is fed into the mould cavity 16 by the forward stroke of the valve element 42, so that very little material that may have solidified in the transition passage 38, is fed into the mould cavity (which could mark the moulded product) and also, the eventual position of the valve element 42 at the end of its forward stroke is much easier to predict than in the case where the valve element serves to “pack” the mould cavity by feeding a larger volume of material into the mould cavity 16.

The flow of coolant inside the valve elements 42 is controlled with valves (not shown) separately from the flow of coolant in the rest of the mould 10, to allow for accurate and efficient cooling of the leading face 43 and to allow for a shift in the cooling timing of the leading face 43 compared to the cooling of the bounding wall 14.

The invention is described herein above with reference to the injection moulding of molten thermoplastic material, which involves heating and cooling of the material. However, the invention also applies to moulding a wide variety of other materials, e.g. thermosetting materials, ceramics, or any other flowable material that needs to be fed to a mould.

The feature of the invention of providing the valve elements 42 inside the mould 10, rather than on the outsides of the platens of the injection moulding press, means that the strokes of the valve elements can be kept short and the hydraulic cylinders 46 driving them can fit inside the mould. Further, the shorter strokes of the valve elements 42 assist greatly in managing the temperature of the leading faces 43 because only a short length of each valve element is repeatedly exposed to the heat of the valve body 36 and flowing material—and then needs to be cooled during the freezing phase of each cycle.

The feature of the invention of providing the valve elements 42 inside the mould 10, has a further advantage that it allows for multiple valve elements to be used with a conventional injection moulding press, with only a single supply port in its platens, rather than having to manufacture special platens with apertures through which multiple valve elements can feed material to the mould cavity 14.

The eccentric joining of the branch flow passage 32 to the transition passage 38 ensures that the flow of material through these passages remains undivided and it does not split up (e.g. around the valve element 42)—which would cause unwanted weld-lines. The elimination of weld-lines is extremely important in fibre reinforced materials, because the fibres themselves and the distribution of fibres do not extend continuously across weld-lines and accordingly, moulded fibre-reinforced articles are significantly weaker along weld lines.

Of the most prominent causes for breakage of reinforcing fibres when injection moulding fibre reinforced materials, are the small sizes (typically less than 8 mm) of the flow passages (runners, gates, etc.) through which the moulding material flows and the high flow rates, pressure and shear that occurs in the flow of moulding material. These effects are exacerbated by the flow paths that include sharp bends —typically at right angles.

However, in the present invention, each of the flow passages (30, 32 38) has a diameter of at least 10 mm (typically much more), requiring a lower flow rate of moulding material in these passages—typically less than 1 m/s, and requiring lower injection pressures. Further, fibre breakage is minimised by the smooth curves in the flow passages.

The invention allows for the moulding of significantly different size components in a single mould, because multiple branch flow passages 32 and multiple valves (comprising the valve body 36 and packing piston 42, collectively) can have different sizes to allow different volumetric flow rates to different mould cavities and/or the valves can be closed in any sequence and thus, the sizes of these components and the operating sequence for the valves can be selected to fill each of the mould cavities at a desired rate, while keeping the flow rates of the moulding material below 1 m/s and avoiding excessive breakage of reinforcing fibre in the moulding material.

The sequential operation of the valves includes operation of valves after one another, but also operation of some or all of the valves at the same time.

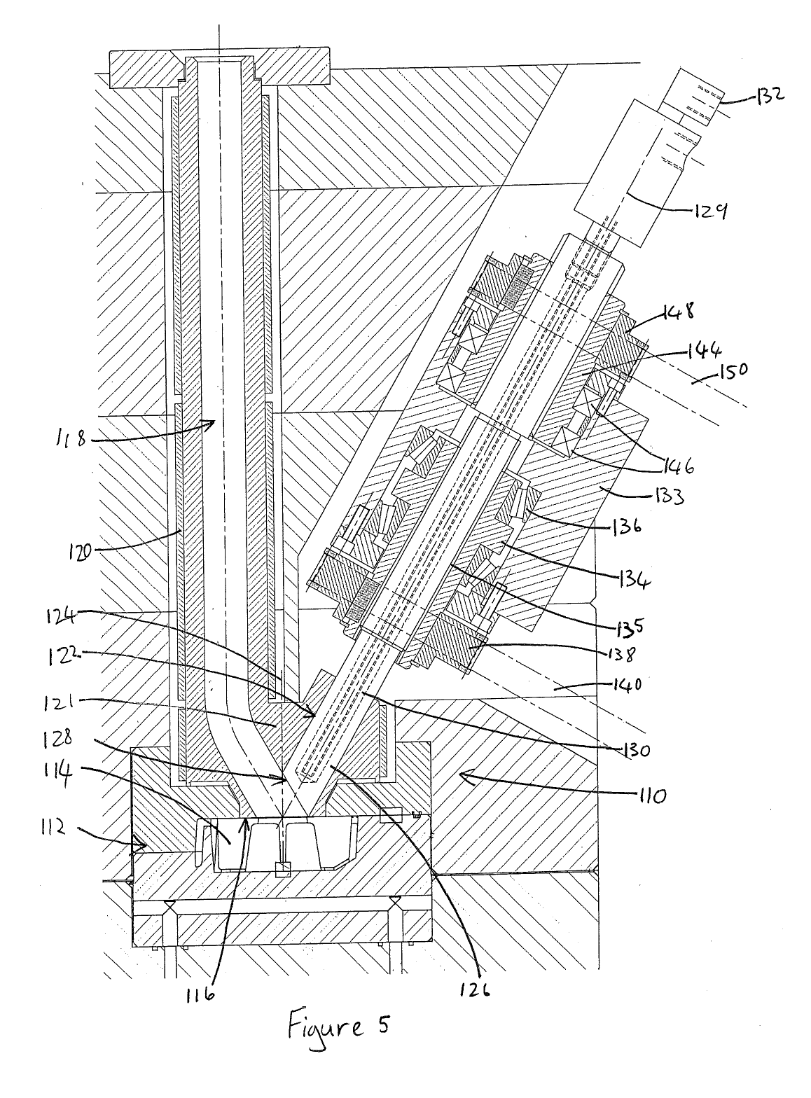

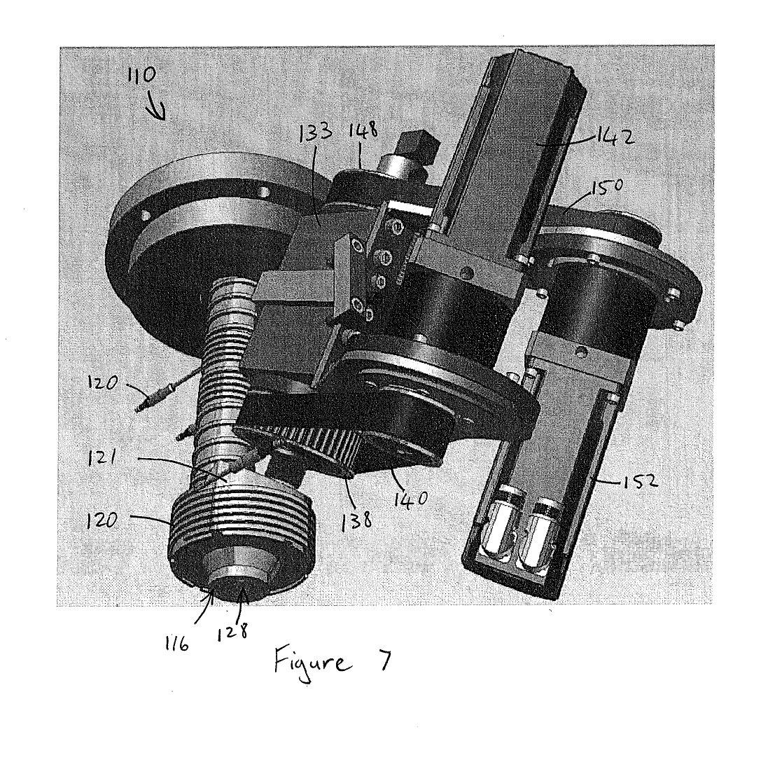

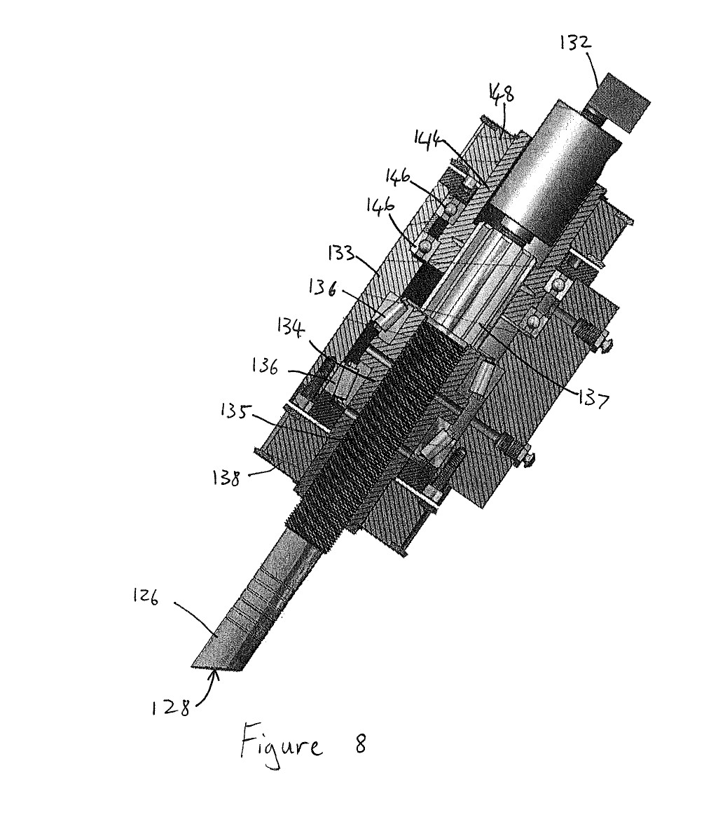

Referring to FIGS. 5 to 8, an alternative embodiment valve in accordance with the present invention is generally indicated by reference numeral 110.

The valve 110 is used in a mould 112, e.g. a mould suitable for injection moulding, in which a mould cavity 114 is defined, bounded on at least one side by a bounding wall 116. The mould includes a supply passage for supplying mouldable material to the mould cavity 114 and part of the supply passage is in the form of a melt channel 118 that leads from an outside of the mould 112 and is heated by spiral heating elements 120. The melt channel 118 can have any orientation and should preferably only include gentle curves and its lower end preferably extends at an angle of about 60 degrees relative to the bounding wall 116, at the point where the melt channel 118 enters the mould cavity 114 via an opening or gate 117.

The flow passage further includes a cylindrical barrel 122 that is defined in a valve body 121 (that also defines the melt channel 118) and the barrel extends at an angle of about 60 degrees relative to the bounding wall 116, preferably at an orientation that mirrors the orientation of the lower end of the melt channel 118, relative to a mirror axis 124 that extends generally perpendicular to the bounding wall 116. The melt channel 118 is in flow communication with the barrel 122 immediately outside the bounding wall 116.

A cylindrical piston 126 is reciprocally displaceable longitudinally along the barrel 122 and can rotate within the barrel, about the longitudinal axis 129 of the barrel. The piston 126 has a leading face 128 that is oriented at about 60 degrees relative to the longitudinal axis of the barrel. The piston 126 fits tightly inside the barrel 122 in a sealing manner and both the piston and barrel are cylindrical with a common longitudinal axis 129.

The piston 126 defines an internal flow passage or cooling passage 130 that can be connected to a source of coolant, e.g. chilled water or air. The cooling passage 130 preferably receives coolant along the axis of the piston, brings the coolant in close proximity to (and thus also in close thermal contact to) the leading face 128 to cool the leading face and then drains the coolant along an annular part of the cooling passage, while also cooling the rest of the piston. The coolant is supplied to the piston 126 via a rotary union 132 which runs on ball bearings and which seals the coolant with a mechanical seal during rotary movement of the piston.

Outside the barrel 122, the piston 126 is connected to an actuating mechanism to open and close the valve 110. The actuating mechanism includes a housing 133 that is held stationary relative to the mould. The piston 126 extends outside the barrel 122 into the housing 133 and inside the housing, the piston includes a threaded section 135 and a longitudinally splined section 137.

The actuating mechanism includes a spindle nut 134 that runs on taper bearings 136 and that engages the screw thread of the threaded section 135 of the piston 126. The spindle nut 134 is driven via a pulley 138 and timing belt 140 from an electric motor 142. When the motor 142 drives the spindle nut 134, it causes the piston 126 to move longitudinally relative to the housing 133 and the barrel 122.

The actuating mechanism also includes a spline bush 144 that rotates relative to the housing 133 on deep groove ball bearings 146 and that engages the splined section 137 of the piston 126. The spline bush 144 is driven via a pulley 148 and timing belt 150 from a stepper motor 152. When the motor 152 drives the spline bush 144, it causes the piston 126 to rotate about its longitudinal axis relative to the housing 133 and the barrel 122.

It is important to note that operation of the motor 142 causes longitudinal (axial) movement of the piston 126, but during this movement, the splined section 137 of the piston slides longitudinally relative to the spline bush 144, which does not move longitudinally.

The actuating mechanism has been described and illustrated using electrical drives to operate the valve 110, and the electrical operation certainly holds advantages, but if desired, the valve could be operated by other means, e.g. hydraulically, pneumatically, mechanically, or by a combination of these drive mechanisms.

In a preferred embodiment, no hydraulics are used in the actuating mechanism, because hydraulics are prone to failures such as leaks and hydraulic cylinder failure, which require removal of the mould from the injection moulding machine and dismantling of the mould to fix the hydraulics inside the mould. The electrical actuating mechanism is not only more compact and reliable, but can be mounted outside the mould 112 (with simple mechanical transfer of the driving movements to the piston) and can be services easily outside the mould.

The use of servomotors 142,152 to control the movements of the piston 126 ensures a high degree of operational reliability and the positioning is substantially more accurate and consistent than with prior art piston operations.

Further, it would be preferable if both motors 142,152 could be stepper motors, because they are more cost effective—particularly more cost effective to control than servomotors. However, the motors 142,152 can be exposed to torque and need to maintain their correct position. Accordingly, it may be preferable to use servomotors, which tend to be more resistant to torque than stepper motors.

In use, when the mould cavity 114 needs to be filled with mouldable material, the valve 110 is in an open condition with the piston 126 in a retracted position as shown in FIG. 5. In this position, the piston 126 is retracted from the mould cavity 114 and its leading face 128 is oriented at an angle of about 60 degrees relative to the bounding wall 116 and is aligned with the lower end of the melt channel 118. The part of the barrel 122 between the leading face 128 and the mould cavity 114 thus forms an open flow passage that is aligned with the lower end of the melt channel 118.

The leading face 128 of the piston 126 forms part of the bounding wall of the flow channel leading into the mould cavity 114 in such a way that the flow channel continues smoothly from the melt channel 18 into the mould cavity, without protruding edges or diversion channels around which the mouldable material needs to flow just before entering the mould cavity 114, or which could cause stagnation of the mouldable material in front of the piston 126 while the mould cavity is being filled. (Such stagnant material would typically have solidified and be deposited as the last bit of material forced into the mould cavity 114, according to the prior art.)

With the present invention, the pressure in the mouldable material can be maintained much longer than in the prior art, before having to close the valve 110. This is because of the shape of the junction of the barrel 122 and the melt channel 118 creating a cavity which increases in size away from the mould cavity 114 and towards the melt channel 118. This in turn causes virtually all the mouldable material in front of the piston 126 to be displaced backward into the melt channel 118 and not forward into the mould cavity 114 as in the case of prior art pistons.

Further, the cross section of the flow passage remains generally uniform right up to entry into the mould cavity 114. There is an absolutely smooth and uniform transition of the flow of mouldable material from the melt channel 18 to the mould cavity 114, with no restriction or deviation of the flow of mouldable material due to the piston 126 being in the way—which reduces the likelihood of breakage of long reinforcing fibres in the mouldable material.

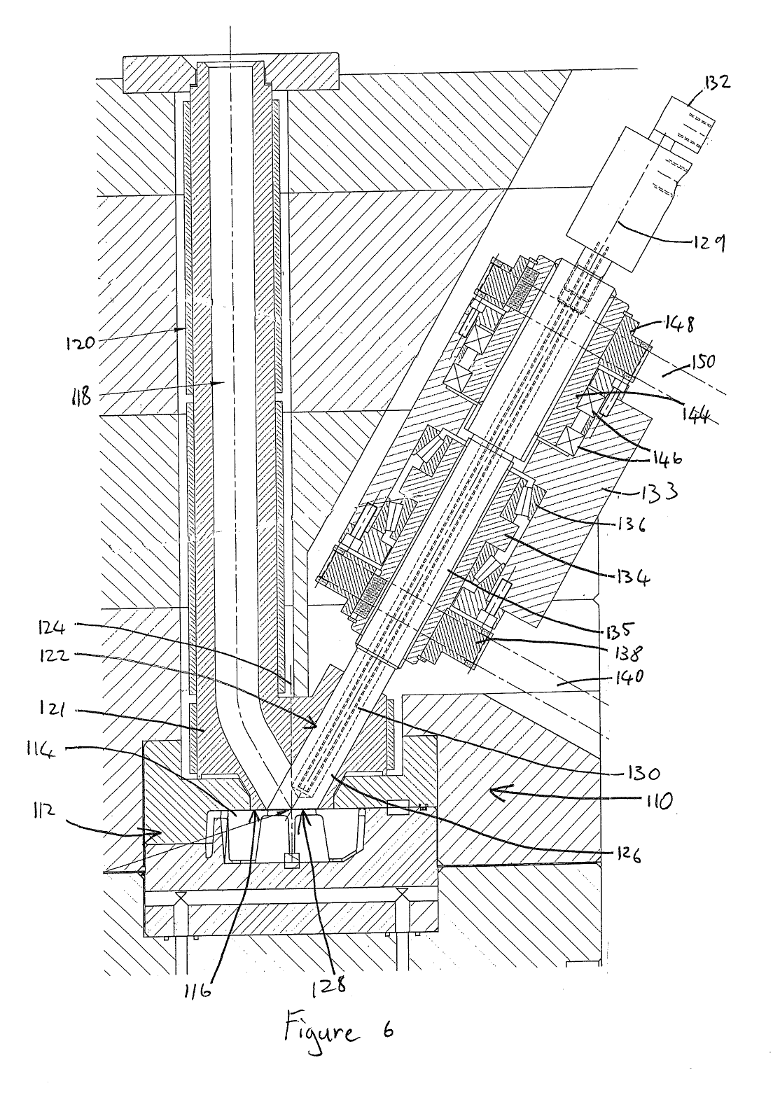

Once the mould cavity 114 has been filled with mouldable material the valve 10 is closed by displacing the piston 126 longitudinally as described above in a forward stroke until the centre of its leading face 128 is generally aligned with the bounding wall 116 and rotating the piston as described above through about 180 degrees, until its leading face is generally aligned with the bounding wall of the mould cavity, in a forward position of the piston, as shown in FIG. 6.

The longitudinal displacement and rotation of the piston 126 can take place in any order, as preferred. If the longitudinal displacement takes place first, the leading end of the piston 126 will temporarily protrude into the mould cavity 114 until the piston is also rotated. Accordingly, if this is not acceptable, rotation of the piston 126 needs to start earlier. The distance that the piston 126 needs to be displaced longitudinally is only slightly more than half the diameter of the piston or barrel 122 and accordingly, the volumetric compression of mouldable material that takes place during this longitudinal movement is relatively small and accordingly, the forces involved are relatively small. Further, during pure rotation of the piston, the combined volume of the barrel 122 and the mould cavity 114 does not change and accordingly, practically no pressure needs to be exerted on the mouldable material to achieve rotation of the piston 126.

The longitudinal displacement of the piston 126 is very low (only about a quarter of that required for a piston as described and illustrated in WO 2007/049146). The result is that less of the mouldable material in the mould is disturbed and less of the mouldable material needs to be forced into the mould cavity 114 at the end of cavity filling.

The flow communication between the melt channel 118 and barrel 122 is only closed at the very last moment when the piston 126 reaches its forward position. Accordingly, until the end of the closing movement of the piston 126, the melt channel 118 is in flow communication with the mould cavity 114 via the barrel 122 and the pressure of the mouldable material in the mould cavity and flow passage can be controlled externally from the mould 112 (via the melt channel 118) and need not be affected by movement of the piston 126. In a preferred embodiment, the valve 110 is closed by simultaneous rotation and longitudinal displacement of the piston 126, such that the piston 126 does not protrude significantly (or preferably not at all) into the mould cavity 114 and the flow communication between the melt channel 118 and barrel 122 is maintained until the end of the closing movement, when the valve 110 is closed by a small rotation and small longitudinal movement of the piston 126—which does not cause substantial compression of mouldable material and accordingly does not require very large forces. (In many instances, this minimal final compression as the piston 126 reaches its forward position could compensate for shrinkage of the mouldable material during the rest of the moulding cycle.)

Once the valve 110 has closed, the mouldable material in the mould cavity is allowed to solidify and this is achieved by cooling of the bounding wall 116, as well as cooling of the leading face 128, which is aligned with/forms part of the bounding wall when in its forward position. Once the mouldable material has solidified, the mould is opened, the moulded article ejected, and the mould closed again for another moulding cycle.

Before the next moulding cycle can commence, the valve needs to be opened and this is achieved by retracting the piston 126 longitudinally and rotating it in the barrel, as described above, until the piston has returned to its retracted position.

The forces required to move the piston 126 longitudinally and to rotate it in the barrel 122 are much lower than in comparable prior art moulding methods (e.g. in WO 2007/049146) and as a result, relatively simple and compact electrical drives can be used for actuation of the piston 126. The compact size of the actuating mechanism for the piston 126 means that the size of the entire mould 112 can be substantially smaller, which reduces the cost of the moulds—especially in the case of large moulds such as moulds for injection moulding of pallets.

The 60 degree orientation of the melt channel 118 and barrel 122 relative to the bounding wall 116 has the result that the opening between the barrel and the mould cavity 114 is oval in outline and is larger than the cylindrical melt channel and barrel (which preferably have about the same diameter). The oval opening between the barrel 122 and the mould cavity 114 is 8% larger than would have been the case if the barrel were perpendicular to the bounding wall 116. The larger size of the opening is preferable because it improves flow of the mouldable material into the mould cavity 114, reduces shear and damage to fibres, etc.

The 60 degree orientation of the melt channel 118 and barrel 122 results in very few bends in the flow passage, which improves flow of the mouldable material and simplifies manufacture of the mould 112 flow passage.

Only a small part of the piston 126 is inside the heated valve body 121 at the end of the melt channel 118 adjacent the bounding wall 116, resulting in a reduced likelihood that the piston will seize inside the valve body. The cooling of the piston 126 is more efficient than in the case of comparable prior art (e.g. a piston as described and illustrated in WO 2007/049146) and the cooling is more concentrated near the leading face 128 and less cooling is required on the sides of the piston. As a result, better (less prominent) piston marks are left on the moulded products and the cycle time for the moulding process is shorter than in the prior art.

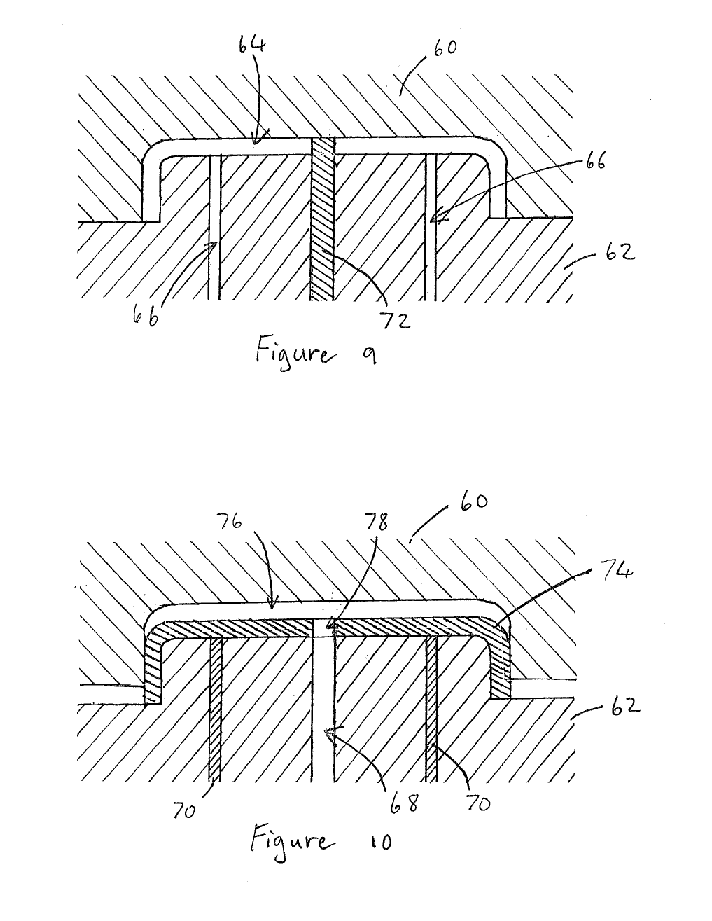

Referring to FIGS. 9 and 10, a moulding method is shown that includes various elements of the features describe above and that allows a product or article to be manufactured by injection moulding in a single mould, in a conventional injection moulding machine, with one material covering another.

A mould is provided which includes a first mould part 60 and a second mould part 62 and when the mould is closed, as shown in FIG. 9, a mould cavity 64 is formed between the two mould parts. Multiple flow passages lead from supplies of flowable moulding material to the mould cavity 64, but for the purpose of illustration, an outer pair of flow passages 66 are shown, as well as a central flow passage 68. The exit of each of these flow passages is selectively closed off by a valve and for the purpose of illustration, the valves closing off the outer pair of flow passages 66 are represented by pistons 70 and the valve closing off the central flow passage 68 is represented by a piston 72.

The valve represented by the piston 72 preferably includes a valve body and packing piston as described above with reference to FIGS. 1 to 4, although the stroke of the piston is long enough to extend to the bounding wall on the opposing side of the mould cavity 64, i.e. to butt against the first mould part 60 as shown in FIG. 9. The valves represented by the pistons 70 can also be of the type described above with reference to FIGS. 1 to 4, but are preferably of the type described with reference to FIGS. 5 to 8 and their pistons need not extend beyond the adjacent bounding wall of the mould cavity 64, i.e. beyond the bounding wall formed by the second mould part 62.

In use, the mould is closed by pressing the parts 60 and 62 together and the outer flow passages 66 are opened by withdrawing the pistons 70, as shown in FIG. 9. The pistons 70 are omitted from FIG. 9, by way of illustration, but they would normally only be withdrawn to extent required in the type of valve, to open the flow passages 66 to the mould cavity 64. The piston 72 is advanced to close off the central flow passage 68 and is advanced to extend across the mould cavity 64 and but against the bounding wall on the opposite side of the mould cavity (i.e. against part 60), as shown in FIG. 9.

A first moulding material flows along the flow passages 66 into the mould cavity 64, the pistons/valves 70 are closed and the material in the mould cavity is allowed to solidify (i.e. to freeze in the case of moulding thermoplastic materials), thus forming a first part 74 of the product. The first part 74 has an aperture 78 extending through it at the position where the central piston 72 extended across the mould cavity 64. The number, size and operating sequence of the flow passages 66 and valves/pistons 70 can be selected as described above with reference to FIGS. 1 to 4.

Once the first part 74 of the product has been moulded, the first and second parts 60,62 of the mould are moved apart so that an ancillary mould cavity 76 is formed, adjacent the first part 74, as shown in FIG. 10. The central piston 72 is withdrawn so that the central flow passage 68 is open to the ancillary mould cavity 76 via the aperture 78 and the ancillary mould cavity is filled with moulding material along the central flow passage 68. The piston 72 is advanced again to close the central flow passage 68 and the material in the ancillary mould cavity 76 is allowed to freeze, before the product is de-moulded.

Depending on the extent to which the ancillary mould cavity 76 (and thus the second moulding material) should extend around the first moulded part 74, the first part of the mould 60 can be more complex, e.g. it could include more parts that move in more directions relative to one another, it could include parts (e.g. inserts) that are removed once the first part 74 has been moulded, or the like , but for the purposed of illustration, it is shown as a single part that is withdrawn in a single direction.

The first mould part 60 can be used adjacent the movable platen of a conventional injection moulding press and the second mould part 62 can be used adjacent the stationary platen of such a press, with supplies of the moulding materials to the flow passages 66 and 68 flowing through a central aperture in the stationary platen and with the valves represented by the pistons 70 and 72 being provided within the second mould part 62 as described above with reference to FIGS. 1 to 4. Accordingly, the method can be implemented on a conventional injection moulding machine.

The method illustrated in FIGS. 9 and 10 allows for an outer surface of a first injection moulded part 74 of a product to be covered by a second moulding material, without any markings on the outer surface, resulting from injection of the second material. The first part 74 could be made from materials with characteristics such as strength and/or low cost, while the material on the outer surface could be a material with a desired appearance such as an “A grade” finish a preferred tactile appeal, or the like.

The features described above allow for the moulding of a plurality of parts for assembly to form a product. The parts for forming the product may have vastly different shapes and sizes and the mould cavities for moulding the parts can all be defined in a single mould, so the parts can be moulded together. Preferably, the mould, flow passages and valve elements are as described above with reference to the drawings, with multiple flow passages leading to the multiple mould cavities and a valve element disposed to close off each flow passage.

The filling of the various mould cavities can take place in any sequence (consecutively, simultaneously, overlapping completely or in part, etc.) and the flow passages and valve elements can be sized to ensure that the pressures, flow rates, and preferably the filling times for each of the mould cavities are about the same. The use of the techniques described above allows the flow passages to be large (with diameters of 10 mm or larger) and accordingly, the mould cavities can be filled quickly at relatively low pressures and with flow rates of the mouldable material being relatively low—preferably below 1 m/s.

In order to control the flow rates, filling rates, pressures, etc of the diversely shaped and sized moulds, it is typically necessary to control and time the operation of the valve elements very accurately and this can be achieved in a simple and cost-effective manner with the electrical operation of the valves described above with reference to FIGS. 5 to 8. Instead, some or all of the valve elements may be reciprocally displaceable pistons as described above with reference to FIGS. 1 to 4.

The mould may be closed before or after the mouldable material is fed to the mould cavities.

The desirable features of the invention are best achieved by designing said cavities of said mould to produce the different parts of a to-be-assembled product in a single mould and during the same production cycle. Mouldable material with or without fillers is melted in a compounder/extruder and dispersed to a heated vessel which maintains the mouldable material in its molten condition. A measured charge of mouldable material is fed to each holding cavity between said pistons and its corresponding mould cavity. When all of said pistons are simultaneously or sequentially displaced forward, mouldable material fills each cavity to form each of the components of the to-be-assembled product.

When the production cycle is completed and said mould is opened, the different parts of said to-be-assembled product are removed. Preferably these components are then directly sorted and assembled, manually or mechanically, into said assembled product. This enables just-in-time production in a single mould and assembly of to-be-assembled products on-site and in-step with other activities. For example, the parts of dispensers for liquid soaps can be produced and assembled on-site where containers are filled, instead of having such dispensers produced and assembled elsewhere or needing a number of moulds to produce the different parts when production is on-site. In cases where the dispensers is produced and assembled elsewhere, the assembled dispensers have to be transported separately to the filler's operations and stocks be maintained there to ensure continuity of production of filled containers.

1. A method of closing a flow passage leading to a cavity, said method comprising:
providing a piston that is reciprocally displaceable in a barrel and that is rotatable about a longitudinal axis of the barrel, part of said barrel forming part of said flow passage adjacent the cavity;
wherein said barrel is orientated at an angle of between 40 degrees and 80 degrees relative to a bounding wall of the cavity, and said piston has a leading face oriented at between 40 degrees and 80 degrees from the longitudinal axis of the barrel;
displacing the piston longitudinally in the barrel in a forward stroke until the centre of its leading face is generally aligned with the bounding wall of the cavity; and
rotating the piston about the barrel's longitudinal axis until its leading face is generally aligned with the bounding wall of the cavity, in a forward position of the piston.

2. A method according to claim 1, wherein the barrel is oriented at an angle of between 50 degrees and 70 degrees relative to the bounding wall and the leading face of the piston is oriented at between 50 degrees and 70 degrees relative to the longitudinal axis of the barrel.

3. A method according to claim 1, wherein the barrel is oriented at an angle of 60 degrees relative to the bounding wall and the leading face of the piston is oriented at 60 degrees relative to the longitudinal axis of the barrel.

4. A method according to claim 1, wherein the cavity is a mould cavity.

5. A method according to claim 1, which comprises opening the flow Passage—by:
displacing the piston longitudinally in the barrel in a return stroke until the centre of the leading face is retracted from the bounding wall of the cavity; and
rotating the piston about the barrel's longitudinal axis, until the piston is in a retracted position.

6. A method according to claim 1, which comprises displacing the piston longitudinally in the barrel by a distance about half the diameter of the barrel.

7. A method according to claim 1, which comprises rotating the Piston—about the barrel's longitudinal axis through about 180 degrees.

8. A method of moulding an article, said method comprising:
opening a valve by: displacing the piston longitudinally in the barrel in a return stroke until the centre of the leading face is retracted from the bounding wall of the cavity; and rotating the piston about the barrel's longitudinal axis, until the piston is in a retracted position;
passing mouldable material along said flow passage into the cavity, said flow passage including a supply passage and the part of the barrel that is between the cavity and the leading face of the piston;
closing the valve according to claim 1; and
allowing the mouldable material to solidify.

9. A method according to claim 8, which comprises a subsequent step of cooling the leading face of the piston.

10. A valve for closing a flow passage leading to a cavity, said valve comprising:
a piston that is reciprocally displaceable in a barrel and that is rotatable about a longitudinal axis of the barrel, part of said barrel forming part of said flow passage adjacent the cavity, said barrel being orientated at an angle of between 40 degrees and 80 degrees relative to a bounding wall of the cavity, and said piston having a leading face oriented at between 40 degrees and 80 degrees from the longitudinal axis of the barrel; and
a supply passage in flow communication with the barrel in close proximity to the bounding wall of the cavity, said supply passage and barrel forming part of the flow passage.

11. A valve according to claim 10, wherein the barrel is oriented at an angle of between 50 degrees and 70 degrees relative to the bounding wall and the leading face of the piston is oriented at between 50 degrees and 70 degrees relative to the longitudinal axis of the barrel.

12. A valve according to claim 10, wherein the barrel is oriented at an angle of 60 degrees relative to the bounding wall and the leading face of the piston is oriented at 60 degrees relative to the longitudinal axis of the barrel.

13. A valve according to claim 10, wherein the cavity is a mould cavity.

14. A valve according to claim 10, wherein the supply passage joins the barrel with an orientation that generally mirrors the orientation of the barrel, relative to a mirror axis that extends generally perpendicular to the bounding wall of the cavity.

15. A valve according to claim 14, wherein the supply passage joins the barrel with an orientation at an angle of about 60 degrees relative to the bounding wall of the cavity.

16. A valve according to claim 10, wherein the piston defines an internal flow passage that is connectable to a source of coolant and that is in thermal contact with the leading face of the piston.

17. A valve according to claim 10 wherein' the flow passage is in communication with the cavity via an opening defined in the bounding wall and said opening has an oval shape and has a cross-sectional area that is about 8% larger than the cross-sectional area of the flow passage.

18-34. (canceled)

35. A method of injection moulding an article with a flowable material including long glass fibres, wherein fibre breakage is inhibited, said method including:
feeding the flowable material under pressure to an inlet port of a mould;
feeding said flowable material from said inlet port into a mould cavity, via a flow passage, a transition passage and a discharge port, all defined in the mould;
closing communication between the flow passage and the transition passage and feeding said flowable material from the transition passage into the mould cavity with a forward stroke of a valve element along the transition passage; and
closing the discharge port with the leading face of the valve element at the end of its forward stroke, such that the leading face of the valve element becomes part of the bounding wall of the mould cavity;
wherein the valve element is disposed inside the mould;
wherein each of said flow passage, transition passage and discharge port has a diameter of more than 10 mm and all bends in the flow passage and transition passage are smooth and rounded.

36. A method according to claim 35, wherein the flow rate of flowable material in the flow passage and transition passage does not exceed 1 m/s.

37. A method according to claim 35, wherein the valve element starts its forward stroke while the flowable material is still flowing from the flow passage into the transition passage, so that the flow of flowable material is uninterrupted during the process.

38. A method according to claim 35, wherein the mould cavity is filled with said feed of flowable material before the valve body starts its forward stroke.

39. A method according to claim 38, which comprises keeping the flowable material in the flow passage and transition passage under pressure until the valve body ends its forward stroke.

40. A method according to claim 35, which comprises feeding said flowable material to the mould cavity via multiples of said flow passages, transition passages and discharge ports, and urging the flowable material from each transition passage into the mould cavity with one of the valve elements.

41. A method according to claim 40, which comprises feeding said flowable material to said flow passages from a common inlet port on the mould.

42. A method according to claim 40, wherein the forward strokes of said valve elements take place sequentially.

43. A method according to claim 35, which comprises cooling the valve element at least in part, and at least when the rest of the bounding wall of the mould is cooled.

44. A method according to claim 43, which comprises controlling the cooling of the valve element.
